(19) United States
(12) Patent Application Publication
(10) Pub. No.: US 2009/0133035 A1
(43) Pub. Date: May 21, 2009

(54) Method and system for developing and deploying converged services

(76) Inventors: Devasis Bassu, Bedminster, NJ (US); Hiralal Agrawal, Bridgewater, NJ (US); Ashish Jain, Bridgewater, NJ (US); Christopher Lott, Morristown, NJ (US); Saul London, Highland Park, NJ (US)

Correspondence Address: TELCORDIA TECHNOLOGIES, INC., ONE TELCORDIA DRIVE 5G116, PISCATAWAY, NJ, 08854-4157, US

(21) Appl. No.: 11/985,973

(22) Filed: Nov. 19, 2007

(51) Int. Cl. G06F 9/54

(52) U.S. Cl. 719/313

(57) ABSTRACT

An inventive system and method for developing and deploying converged services having incoming messages from a network and/or a service includes a graphical front end for creating flows having one or more event match criteria, each event match criteria having corresponding logic, a generator for generating runtime code from the flows, and a runtime engine operable to perform the runtime code, in which an incoming message is matched to one of the event match criteria and the corresponding logic is executed. The logic can be logic performed by the converged service. A user of the inventive system can switch between the flow created in the graphical interface and the runtime code generated from the flow.

### FIELD OF THE INVENTION

The present invention relates generally to network services, and, more specifically, to a system and method for developing and deploying converged services.

### BACKGROUND OF TEE INVENTION

Creating network services offerings for customers, including video, voice, and data, often requires working with several networks that each use different messaging formats and protocols. Using present day platforms for creation of “converged services”, that is, services combining messaging from multiple networks, is difficult because the service developer not only needs a thorough understanding of programming languages, but also a comprehensive understanding of messaging and networking protocols.

The traditional approach to expanding network services and creating new converged service offerings is to develop software such as computer programs that manipulate incoming messages, and, during execution, usually send out one or more outgoing messages to other systems. Correlating incoming messages is part of the software or program's instructions specified by the service's software developer. Accordingly, upon commencement of the program's execution, the program performs initialization and then the program is either executing instructions, or sending outgoing messages, or waiting for incoming message(s). The “wait” state is generic, and the burden is on the programmer to specify, using programming instructions, logic to distinguish among incoming messages so that appropriate message handling processing can be applied. This is the typical service execution model available today; examples include standard Java HTTP (Hyper-Text Transfer Protocol), and SIP (Session Initiation Protocol) Servlets programming and execution environments that employ HTTP and SIP message formats.

The prior art approach necessitates that execution logic to correlate outgoing and incoming messages or requests and responses for a variety of distinct message formats, e.g., HTTP, SIP, DIAMETER, SOAP, GDI, TCAP, etc., be created individually for each program in a service.

### BRIEF SUMMARY OF THE INVENTION

The present invention advantageously provides a service creation and execution platform that implements a unified representation for all the messages and the protocols, so that the developer can focus on programming the service logic using this unified representation. The inventive system and method for developing and deploying converged services having incoming messages from a network and/or a service includes a graphical front end for creating flows having one or more event match criteria, each event match criteria having corresponding logic, a generator for generating runtime code from the flows, and a runtime engine operable to perform the runtime code, in which an incoming message is matched using one of the event match criteria and the corresponding logic is executed. The logic can be logic performed by the converged service. A user of the inventive system can switch between the flow created in the graphical interface and the runtime code generated from the flow.

### BRIEF DESCRIPTION OF THE DRAWINGS

The invention is further described in the detailed description that follows, by reference to the noted drawings by way of non-limiting illustrative embodiments of the invention, in which like reference numerals represent similar parts throughout the drawings. As should be understood, however, the invention is not limited to the precise arrangements and instrumentalities shown. In the drawings:

FIG. 1 is a schematic of an exemplary embodiment of the invention;

FIG. 2 is a schematic of the components of the invention;

FIG. 3 is a schematic of a flow definition;

FIG. 4 is a class diagram in Unified Modeling Language notation illustrating an exemplary embodiment of the invention;

FIG. 5 illustrates an exemplary flow definition; and

FIG. 6 is a schematic of the runtime environment.

### DETAILED DESCRIPTION

A system and method to develop and deploy converged services is presented. In accordance with this invention, a service is specified, translated into the runtime code of the inventive system, and executed on the inventive runtime environment. The inventive runtime environment can be built on top of traditional execution environments. Using the inventive system, a programmer need not develop correlation logic within his program to match incoming messages. Instead, the programmer composes a flow having one or more event match criteria and an associated “callback” for each event match criteria. A callback is the logic executed when an incoming message matching a particular event match criteria arrives at the program.

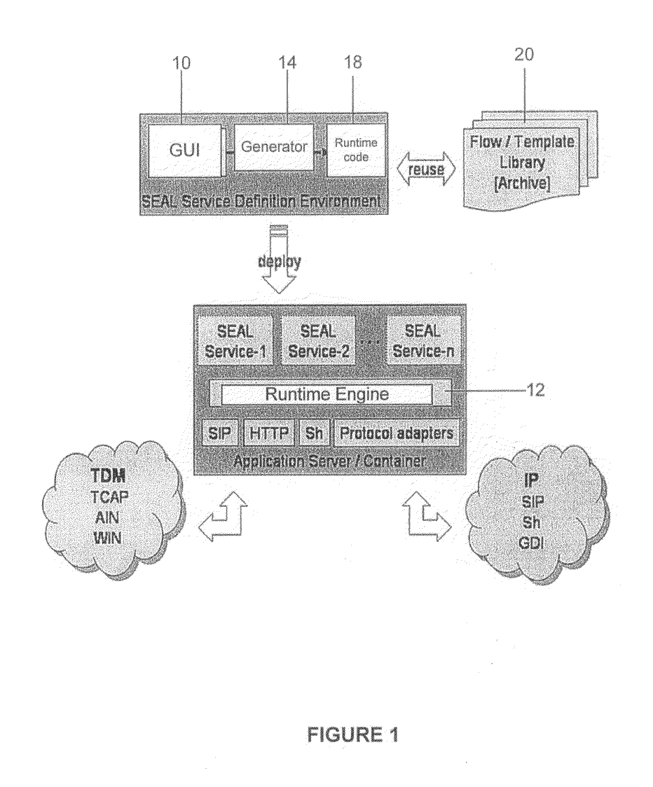

Three core components correspond to the three core aspects of the inventive system and method. FIG. 1 gives an overview of an exemplary embodiment of the invention, including its components. The first component is a Graphical Front End, such as a Graphical User Interface (GUI) 10, that allows developers to develop new converged services by creating converged service specifications and other software. The second component is a Runtime Engine 12 that is a layer built on top of traditional runtime environments. In one embodiment, Java Servlet Runtime Environment is the traditional runtime environment. The third component is a Generator 14 that takes the service specifications developed using the GUI 10 and generates the runtime code to be executed by the Runtime Engine 12. Each component is described in more detail below.

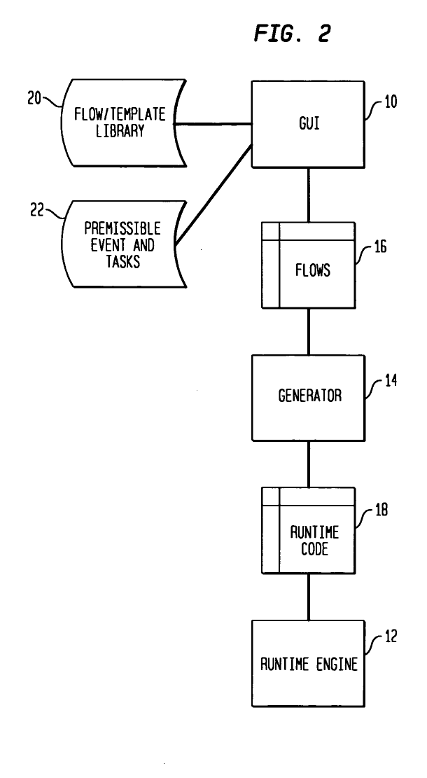

FIG. 2 shows a schematic view of these components and how they fit together. GUI 10 creates flows or flow definitions 16 based on user input and stores these flows 16 and/or templates in the GUI library 20. These flows 16 are converted to runtime code 18 by the generator 14. The runtime engine 12 executes the runtime code 18; details of this process are provided below.

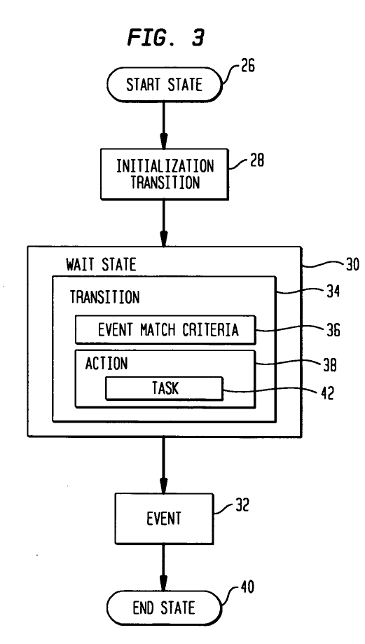

In this inventive system, for a converged service, the system's software or application logic is defined in terms of flows. A schematic diagram of a flow 16 is shown in FIG. 3. Before initialization, a flow 16 is always in the start state 26. The initialization transition 28 determines the next state of the flow. This may be the end state 40 (for a trivial flow) or a wait state 30. A wait state 30 signifies that the flow 16 has completed processing, and is waiting for some event 32, such as a response to a request message, to occur.

A wait state 30 consists of one or more transitions 34, each having two parts: an event match criteria 36, and an action 38. When an event 32, e.g., incoming protocol message, incoming timer message, etc., takes place, all of the transitions 34 of all converged services in the current wait state 30 are compared using the corresponding event match criteria 36 to the event 32. Upon finding a match, the action 38 of the transition 34 having the event match criteria 36 is executed. An action 38 is described in more detail below. After execution of the action 38, the next state of the flow 16 is entered. If the end state 40 is entered, flow execution for the converged service is terminated.

An action 38 consists of zero or more tasks 42. A task 42 may be a sequence of ordinary program statements, such as manipulation of program variables, creation and sending of messages, or use of FlowMessages to invoke and/or continue transacting with another client callable flow 16. A client callable flow 16 is a “building block” or flow sequence that is created using the GUI 10, and made available as a reusable routine or template 16 to all the service developers. A client callable flow 16 has at least one input FlowMessage and zero or more output FlowMessages. The exact mechanism for delegating service processing to client flows using a protocol called FlowMessagingProtocol involving FlowMessages is described in detail below as part of Runtime Engine 12 description.

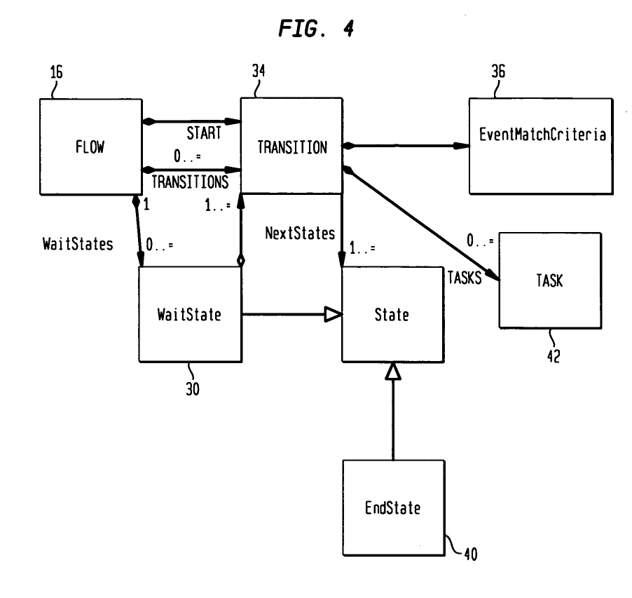

FIG. 4 shows an embodiment represented in Unified Modeling Language notation. A flow 16 has aggregates of a start (or initialization) transition 34 and zero or more additional transitions 34. Each transition 34 has aggregates of one event match criteria 36, and zero or more tasks 42. In addition to transitions 34, each flow 16 has zero or more Wait States 30, also relating to one or more transitions 34. Each transition 34 is associated with one or more states which could either be a wait state 30 or an end state 40.

### Graphical Front End

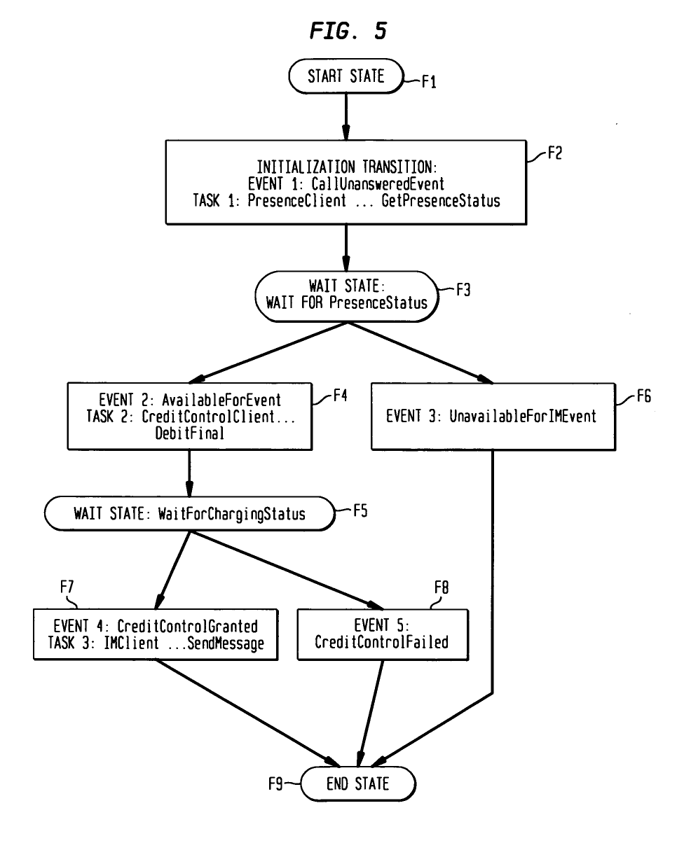

The GUI 10 simplifies the development and deployment of converged services, enabling a user to denote the flow of messages corresponding to the logic in the service application. FIG. 5 shows a flow definition or flow 16 created using the GUI 10. Initially, the flow 16 is in the start state F1. The flow proceeds to the initialization transition F2 that includes an event 32 and a single task 42, specifically, an event “CallUnansweredEvent” with task “getPresenceStatus” that invokes the client callable flow “PresenceClient”. After the event 32 is received and matched with a transition 34 in the wait state 30 of the flow 16 and the corresponding action 38 is performed, the flow 16 proceeds to the next state, e.g., wait state F3, awaiting the next event that matches its event match criteria 36. In F4, a response from the client callable flow “PresenceClient” is received which matches the event “AvailableForEvent” and task “debitFinal” that invokes client callable flow “CreditControlClient” is performed, and flow 16 proceeds to the next wait state “Wait for Charging Status” in F5. Alternatively, if the response from the client callable flow “PresenceClient” matches the event “UnavailableForIMEvent” in F6, flow 16 proceeds to the end state F9 and terminates.

When the charging status response from the client callable flow “CreditControlClient” is received, and matches event “CreditControlGranted”, task “sendMessage” that invokes the client callable flow “IMClient” is performed in F7, and flow 16 proceeds to the end state F9 and terminates. Alternatively, if the charging status response matches event “CreditControlFailed” flow 16 proceeds to the end state F9 and terminates.

The GUI 10 has several innovative features. It provides a unifying way for the service developer or user to specify request messages as part of his service specification. Also, the GUI 10 keeps a data structure, e.g., template library 20, consisting of all the client callable flows 16 available to the user or service developer. Thus, when a user has to select a task 42 to be performed in a transition 34 of the service specification, GUI 10 automatically provides a list of tasks from data structure 20 that includes all of the client callable flows 16. When a user selects a client callable flow 16, GUI 10 helps the user with the creation and specification of the corresponding input FlowMessage data structure. As new client callable flows 16 are added to the workspace, the GUI data structure 20 is automatically updated to include these new flows 16. In one embodiment, the Eclipse resources framework can be used to achieve the update feature.

The GUI 10 also keeps a data structure 22 of all permissible tasks 42 for any transition 34 and all permissible events 32 for any wait state 30 within a flow 16. The data structure 22 is updated as the user makes changes to the flow definition. Thus, based upon the context, that is, a particular wait state 30 or a particular transition 34, the GUI 10 can provide a drop down list of permissible tasks and/or events 22 for a service developer to use to complete the logic of his service specification. Such context sensitive editing helps in developing syntactically correct service specifications.

### Runtime Engine

Services and Application Enabling Layer Run Time (SEAL-RT) is the inventive Runtime Engine 12 that can be built on top of the traditional execution environments. SEAL-RT execution of a flow involves repeated detection of an event 32, matching of the event 32 to the set of transitions 34 for the current wait state 30 using the associated event matching criteria 36, and invocation of the action 38 in the matching transition 34. As discussed above, invocation of an action 38 in a transition 34 means execution of all of the tasks 42 in the transition 34 and then entering the next state. As illustrated above, termination of the flow 16 occurs when invocation of a transition 34 results in the end state 40.

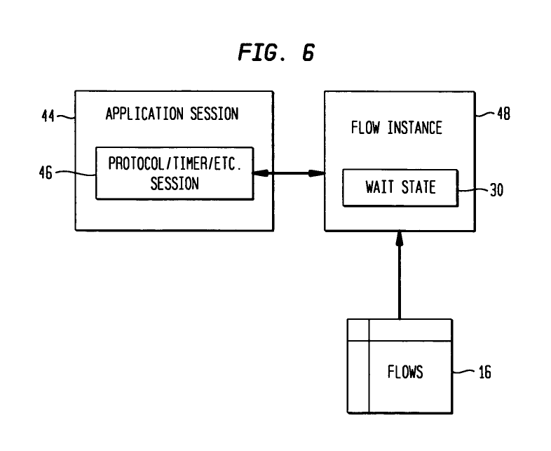

FIG. 6 is a schematic of the runtime environment. In this environment, execution of a service, such as a converged service, involves creation of an application instance called an application session 44. Within each application session 44, several protocol sessions 46, each for sending and/or receiving messages, are created and destroyed. Note that other sessions, such as timer sessions with timer messages, can also occur within an application session 44. Additionally, an application session 44 contains one or more flow instances 48. Within a protocol session 46, several messages can be exchanged. Correlating all the various messages, and tying them to appropriate application sessions 44 and further to the specific flow instance 48 is the core function of SEAL-RT.

### SEAL-RT Flow Execution

An application session 44 or service instance is started when one of the initial conditions for the service is met. Typically, a single execution of any service is represented as an application session 44. Various transactions, e.g., protocol-based, timers, etc., within the application session 44 are each represented and executed as contained protocol sessions 46, timer sessions 46, etc. Each such session 46 is mapped to exactly one flow instance 48 in the SEAL-RT. This mapping may change during the lifetime of the application session 44; however, the mapping must always be one-to-one.

When the application session 44 is started, the SEAL-RT creates a flow instance 48 for the primary flow, which is a special flow definition (not shown), associated with a service, capable of handling the initial event(s) that trigger the service. At runtime, a flow instance 48 executes a flow definition 16. The flow instance 48 includes a reference to the flow definition 16 and the current state of the flow, which may be the initial start state or initialization transition 28, for example if flow execution has not yet started, or a wait state 30, or the end state 40. Note that there may be multiple flow instances 48 for any given flow definition 16.

### SEAL-RT Event Matching

For each incoming message from the network or service as delegated by the application server or container, the following steps are performed.
1. get parent application session 44 and protocol session 46 (if applicable)
2. get the flow instance 48 that is mapped to that protocol session 46 (if the protocol session is unavailable, the primary flow instance is used)
3. retrieve current wait state 30 for the flow instance 48
4. check incoming message or event 32 against all the event match criteria 36 of the related transitions 34 for that wait-state 30
5. execute the action 38 of the matching transition 34

As discussed above, in the inventive system and method, a service developer uses a unified representation for messages and/or events 32. Accordingly, messages need to be translated into the appropriate unified representation before they can be sent over the network. SEAL-RT uses protocol adaptors to translate a request message from its unified representation into the requisite message format, such as an event 32, and to translate a response message from a specific format to the unified representation. There are protocol adaptors for HTTP, SIP, DIAMETER, and other messaging formats.

### SEAL-RT Flow Invocation

SEAL-RT also uses a novel approach to invoke the reusable client callable flows 16 that have been previously created and included in a library 20. To enhance performance, SEAL-RT uses a special protocol called FlowMessagingProtocol, with a data structure called FlowMessages, to delegate execution to, and subsequently exchange information with a client callable flow 16.

The SEAL-RT provides functionality for other flows 16 to be invoked from any given flow 16. For example, FIG. 5 shows the main flow 16 invoking the client callable flows “PresenceClient”, “CreditControlClient” and “IMClient”. Accordingly, the service developer can modularize his service specification or application logic as opposed to having to specify it in a single flow definition 16. Further, the SEAL-RT permits the invoking flow instance 48 and the invoked flow instance 48 to exchange messages and optionally transfer protocol sessions 46. As discussed above, a protocol session 46 is mapped to exactly one flow instance 48. The SEAL-RT transfer mechanism allows the service developer to handover the protocol session 46 to various flows 16 for specialized processing at runtime.

The SEAL-RT uses a simple asynchronous messaging scheme to achieve this flexible message exchange capability. Another immediate benefit of this messaging scheme is the notion of high-level events. Consider two flows A and B established in a flow messaging session. A message sent from A to B is treated just like any other network protocol message; essentially, B can trap this message by specifying an event match criteria as part of a transition. Flow A could be performing complicated transactions on a protocol session and reporting consolidated high level information back to flow B via flow messages. These may then be used by flow B as high-level events to trigger further processing.

The invocation of flow B from flow A is achieved using the same flow messaging protocol. In this case, a special type of flow message, a flow invocation message, is used. Flow A constructs a flow invocation message for flow B and then sends it. This results in the creation of a flow instance of flow B that is initialized using the flow invocation message. A flow messaging session is now established between the two flows. This session may be used for exchanging subsequent flow messages.

Note that a flow instance may be associated with more than one flow messaging sessions at any time, i.e., a flow may invoke one or more other flows.

### Generator

SEAL Service Graphical Editor or GUI 10 is used to specify the flows 16. SEAL-RT, however, is execution of runtime code 18, such as Java Servlet code. The translation of a service flow specification 16 into SEAL service code 18 that SEAL-RT executes is achieved via the SEAL Service Code Generation (SEAL-CG) or generator 14.

The inventive system generates runtime code 18 in-situ, using the generator 14, as the user is specifying a service flow 16 using the GUI 10. Thus, a user can go back-and-forth between the GUI 10 and the code view of the service specification or flow 16.

While the present invention has been described in particular embodiments, it should be appreciated that the present invention should not be construed as limited by such embodiments, but rather construed according to the below claims.

What is claimed is:

1. A system for developing and deploying converged services having incoming messages from a network or a service, comprising:
a graphical front end for creating flows having one or more event match criteria, each event match criteria having corresponding logic;
a generator for generating runtime code from the flows; and
a runtime engine operable to perform the runtime code, wherein an incoming message is matched to one of the event match criteria and the corresponding logic is executed.

2. The system according to claim 1, said graphical front end further comprising a list of permissible events and tasks for any given flow and a flow library having flows.

3. The system according to claim 2, wherein said created flow comprises of events and/or tasks from the permissible list of events and tasks.

4. The system according to claim 1, wherein the matching is performed using the incoming message and an event match criteria in the flow.

5. The system according to claim 1, wherein a user can switch between the flow created in the graphical front end and the runtime code generated from the flow.

6. The system according to claim 1, wherein the corresponding logic is based on converged services specifications.

7. The system according to claim 1, wherein performance of the runtime code creates a parent application session and a protocol session mapped to a flow instance, and when the incoming message is received, a current wait state having transitions for the mapped flow instance is retrieved, and the incoming message is matched to one of the transitions in the current wait state using the corresponding event match criteria.

8. A method for developing and deploying converged services having incoming messages, said method comprising the steps of:
creating flows having one or more event match criteria, each event match criteria having corresponding logic;
generating runtime code from the flows;
performing the runtime code to match an incoming message to one of the event match criteria; and
executing the corresponding logic.

9. The method according to claim 8, further comprising the step of switching between the flow and the runtime code generated from the flow.

10. The method according to claim 8, wherein the corresponding logic is based on converged services specifications.

11. The method according to claim 8, said step of matching further comprising the steps of:
receiving the incoming message;
getting a parent application session and a protocol session;
getting a flow instance mapped to the protocol session;
retrieving a current wait state having transitions for the mapped flow instance; and
comparing the incoming message to all the transitions for the current wait state using associated event match criteria.
